(19) United States
(12) Patent Application Publication
(10) Pub. No.: US 2013/0055044 A1
(43) Pub. Date: Feb. 28, 2013

(54) Method And Apparatus For Restricting The Operation Of USB Devices

(71) Applicants: Faik Eljezovic, Vancouver (CA); Sergei Govorkov, Vancouver (CA); John Alexander McLeod, Vancouver (CA)

(72) Inventors: Faik Eljezovic, Vancouver (CA); Sergei Govorkov, Vancouver (CA); John Alexander McLeod, Vancouver (CA)

(73) Assignee: UNA TECHNOLOGIES CORPORATION, Vancouver (CA)

(21) Appl. No.: 13/347,720

(22) Filed: Jan. 11, 2012

Related U.S. Application Data
(60) Provisional application No. 61/575,579, filed on Aug. 25, 2011.

(51) Int. Cl. G06F 11/10

(52) U.S. Cl. 714/758; 714/E11.044

(57) ABSTRACT

The present invention provides a method and apparatus for blocking the operation of selected USB devices at the hardware level, while allowing the operation of selected USB devices and external USB hubs to continue to operate normally. In particular, the method provides for the restricted operation of one or a plurality of USB devices by altering one or a plurality of data fields contained within a USB transaction. An apparatus for operation of the method is also provided. Control of the use of USB storage devices is provided.

### CROSS-REFERENCES TO RELATED APPLICATIONS

This application claims the benefit of priority of U.S. Provisional Application No. 61/575,579 filed Aug. 25, 2011, the subject matter of which is incorporated herein by reference, in its entirety.

### FIELD OF THE INVENTION

This invention relates to methods and apparatus for transmitting signals between computers and devices over Universal Serial Bus (USB) connections, and in particular, to a method for restricting the operation of one or a plurality of USB devices.

### DESCRIPTION OF THE PRIOR ART

The USB technology has become standard on all new computers that have been built since 1998. At present most computer peripheral devices are USB-based, for example: printers, mice, keyboards, speakers, webcams, external hard drives, digital cameras, flash drives, mobile phones, etc.

The specifications that define the USB protocol have been extended over a number of revisions including Revision 1.0, in January 1996; and updated as Revision 1.1 in Sep. 23, 1998, and further updated as Revision 2.0 in April 2000, and yet further updated as USB 3.0, Revision 1.0 in June 2011 and subsequent updates, additions and modifications—hereinafter collectively referred to as the “USB Specifications”, which term can include future modifications and revisions. The USB specifications are non-proprietary and are managed by an open industry organization known as the USB Implementers Forum (USB-IF). The USB Specifications establish a number of criteria which must be met in order to comply with USB standards. The USB Specifications also define a number of terms, which definitions are adopted for the purposes of this specification.

In common corporate environments, computers are connected to intranets, which allows for safe transfer of information within the intranet. Since the vast majority of computers are equipped with readily accessible USB ports, this creates a potential for the theft of confidential data, or the introduction of malicious software or viruses into computer networks by means of, for example, various USB devices including USB storage devices such as USB flash drives.

Controlling the use of USB storage devices is not an easy task since these devices are very small and are easy to conceal. Removing USB ports from computers is not a viable option since so many other non-storage devices (e.g. keyboards, mice, printers, microphones, speakers, scanners, etc.) require USB ports.

Thus it would be advantageous to be able to block the operation of certain types of USB devices while allowing others to continue to operate as normal.

Additionally, while USB mass storage devices provide a clear-cut use-case for device restriction, there are also situations in which the restriction of other types of device may also be desirable. For example, an organization may have a requirement to block the use of USB scanners to prevent the scanning of sensitive documents or to block the use of USB webcams to prevent the whereabouts of security personnel from being monitored remotely.

While software solutions have been used to block the use of USB flash drives, this has not proven to be an effective solution since software is vulnerable to hackers and each individual operating system (Windows, MAC OS, Linux, etc.) requires a separate software implementation. To improve upon these software-only solutions, some systems employ a mixture of hardware and software to achieve a level of USB device blocking. These systems typically require validation of USB devices on a “safe” USB host controller before the device is allowed access to the main, or operational, USB host controller. These implementations suffer from several practical disadvantages. At the hardware level, they require a duplication of USB host controllers plus the addition of a multi-port switch to pass device control from one host controller to another. The cost of the additional hardware is detrimental to the effectiveness of a low-cost interface such as USB, and the introduction of a switch into the USB data lines diminishes USB signal integrity—a very serious limitation as USB data rates increase with subsequent revisions of the specification. A further significant disadvantage of this approach is that it is unable to provide support for external USB hubs. This limitation arises from the requirement of the system to detect USB device connection events in order to start the authentication process on the safe USB host controller. When a USB device is directly connected to a USB port, the connection event is signalled by an electrical condition on the bus. However, when, a device is connected to a USB hub, this electrical condition is detected by the USB hub and converted to a status change which must be detected at the USB protocol level. This protocol event cannot be detected by the USB port hardware used to detect electrical events. The system must therefore deny access to all external USB hubs to prevent device connections from going unnoticed.

Thus it would be advantageous to be able to block the operation of selected USB devices at the hardware level, without the addition of duplicate USB host controllers with their associated support circuitry and software. It would be further advantageous to be able to block the operation of selected USB devices at the hardware level without the addition of USB switches with their attendant cost and signal integrity disadvantages. It would be yet further advantageous to be able to block the operation of selected USB devices at the hardware level while enabling external USB hubs to continue to operate normally.

### SUMMARY OF THE INVENTION

Accordingly, it would be desirable to restrict or block entirely the operation of certain USB devices without the deployment of additional software and without diminishing the cost-effectiveness and universality of USB hardware. Therefore it is an object of the present invention to restrict the operation of one or a plurality of USB devices using hardware means.

It is a further object of the present invention that there shall be no undesirable effects on USB devices whose operation is not required to be restricted.

It is a further object of the present invention that the range of USB devices to be restricted may be selected dynamically.

It is a further object of the present invention that said one or a plurality of USB devices may independently operate at any of the bus speeds (e.g. 1.5 Mbps, 12 Mbps, 480 Mbps, 5 Gbps) defined by the USB specifications.

It is a further object of the invention that individual functions supported in a multi-functional device may be restricted without adversely affecting other functions supported by that same device.

It is a further object of the present invention that the methods employed to restrict the operation of said plurality of USB devices may be implemented in a variety of hardware technologies, including discrete components, field programmable gate arrays and application specific integrated circuits.

It is a further object of the present invention that the methods employed to restrict the operation of said plurality of USB devices may be integrated with other USB objects such as USB host controllers and USB hubs.

These and other objects of the invention, which will become apparent herein, are fully or at least partially attained by the present invention which invention provides a method and related apparatuses wherein a USB host controller may be connected to one or a plurality of USB devices through a USB restrictor unit.

As such, in a first aspect, the present invention provides a method for restricting the operation of one or a plurality of USB devices wherein said restricted operation is achieved by altering one or a plurality of data fields contained within a USB transaction, wherein said USB transaction is composed of a USB token packet, a USB data packet and an optional USB handshake packet, said method comprising:
a. receiving at a USB restrictor unit a USB token packet;
b. analyzing the constituent fields of said received USB token packet;
c. comparing said analyzed constituent fields with a set of predefined restriction criteria; and

altering one or a plurality of data fields within said USB transaction according to the results of said comparison.

Moreover, the present invention is also directed to an apparatus adapted for use in the practise of the method of the present invention. Accordingly, in a further aspect, the present invention also provides an apparatus for restricting the operation of one or a plurality of USB devices wherein said restricted operation is achieved by altering one or a plurality of USB packets, said apparatus comprising:
a. a decoding unit for capturing the fields of a USB token packet;
b. a comparison unit for comparing said captured fields of said USB token packet with a set of predefined restriction criteria; and
c. an encoding unit for generating a replacement USB DATA packet.

Further, the present invention also provides a method for selecting an appropriate USB data stream. Thus, in a still further aspect, the present invention also provides a method for selecting a USB data stream wherein said USB data stream is directed at an individual endpoint belonging to an individual USB device, said method comprising:
a. capturing at a USB restrictor unit a USB descriptor structure;
b. extracting one or a plurality of fields from said USB descriptor structure;
c. comparing said one or a plurality of extracted fields with a set of restriction criteria; and
d. setting restriction parameters that limit the operation of said USB data stream.

Additionally, the present invention provides a method for detecting the attributes of a USB device, when connected to the system. As such, in a yet still further aspect, the present invention provides a method method for detecting the attributes of a USB device, said method comprising:
a. Capturing at a USB restrictor unit a USB SETUP transaction;
b. Analysing said USB SETUP transaction to determine the presence of a USB GET_Descriptor command;
c. Capturing at a USB restrictor unit one or a plurality of USB IN transactions;
d. Parsing said one or a plurality of USB IN transactions to extract one or a plurality of USB descriptors; and
e. Extracting one or a plurality of descriptor fields from said one or a plurality of USB descriptors.

### DESCRIPTION OF THE PREFERRED EMBODIMENTS

In a preferred embodiment of the present invention, the USB host controller and the one or a plurality of USB devices can be any standard unit that complies with the USB specifications. Preferably, no modifications are required to the hardware or software of said USB host controller or said USB devices. It is further preferred that the USB bus may operate at any of bus speeds defined by the USB specifications.

In a preferred embodiment of a USB restrictor unit, the USB restrictor is a self-contained unit equipped with an upstream port for connection to a USB host controller or a USB hub and a downstream port for connection to a USB device or a USB hub.

In a further preferred embodiment of a USB restrictor unit, the USB restrictor is integrated with a USB host controller and is equipped with a downstream port for connection to a USB device or a USB hub.

In a yet further preferred embodiment of a USB restrictor unit, the USB restrictor is integrated with a USB hub and is equipped with an upstream port for connection to a USB host controller or a USB hub.

It will be apparent to those skilled in the art that a variety of combinations of the aforementioned embodiments is also possible. A typical application of the USB restrictor is in an environment in which access to computer hardware is controlled such that the user has access only to USB ports connected through one or more USB restrictor units. Such an environment may occur when a computer server is located within a secured computer room and a “thin client” is provided at a user workstation. Said thin client can be constructed to include a USB restrictor unit integrated with a USB hub such that only “restricted” USB ports are exposed to the user. An alternative implementation can include an industrial or military-grade computer provided at the user workstation wherein said computer is constructed to include a USB restrictor unit integrated with a USB host controller such that only “restricted” USB ports are exposed to the user.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a block diagram of a typical USB system according to the prior art USB specifications;

FIG. 2 is a block diagram of a USB connection according to the prior art USB specifications;

FIG. 3 is a block diagram of a USB connection according to the present invention;

FIG. 4 is a block diagram of a USB restrictor unit according to the present invention;

FIG. 5 is a block diagram showing a USB restrictor system (50) constructed as a stand-alone unit according to the current invention;

FIG. 6 is a block diagram showing a USB restrictor system constructed by integrating a USB restrictor unit with a USB host controller according to the current invention;

FIG. 7 is a block diagram showing a USB restrictor system constructed by integrating a USB restrictor unit with a USB hub according to the current invention;

FIG. 8 is a waveform diagram showing the structure of a USB OUT transaction according to the prior art USB specifications;

FIG. 9 is a waveform diagram showing the structure of a USB IN transaction according to the prior art USB specifications;

FIG. 10 is a waveform diagram showing the structure of a USB token packet according to the prior art USB specifications;

FIG. 11 is a waveform diagram showing the structure of a USB DATA packet according to the prior art USB specifications;

FIG. 12 is a waveform diagram showing the structure of a USB handshake packet according to the prior art USB specifications;

FIG. 13 is a waveform diagram showing the structure of a USB token packet according to the current invention;

FIG. 14 is a waveform diagram showing the structure of a USB DATA packet according to the current invention;

FIG. 15 is a waveform diagram showing the structure of a USB handshake packet according to the current invention;

FIG. 16 is a flowchart showing a method for identifying a USB packet that may be altered according to the current invention;

FIG. 17 is a table showing the structure of a device descriptor according to the prior art USB specifications;

FIG. 18 is a table showing the structure of a configuration descriptor according to the prior art USB specifications;

FIG. 19 is a table showing the structure of an interface descriptor according to the prior art USB specifications;

FIG. 20 is a table showing the structure of an endpoint descriptor according to the prior art USB specifications; and

FIG. 21 is a flowchart showing a method for capturing descriptor information from a stream of USB traffic.

### DETAILED DESCRIPTION OF THE INVENTION

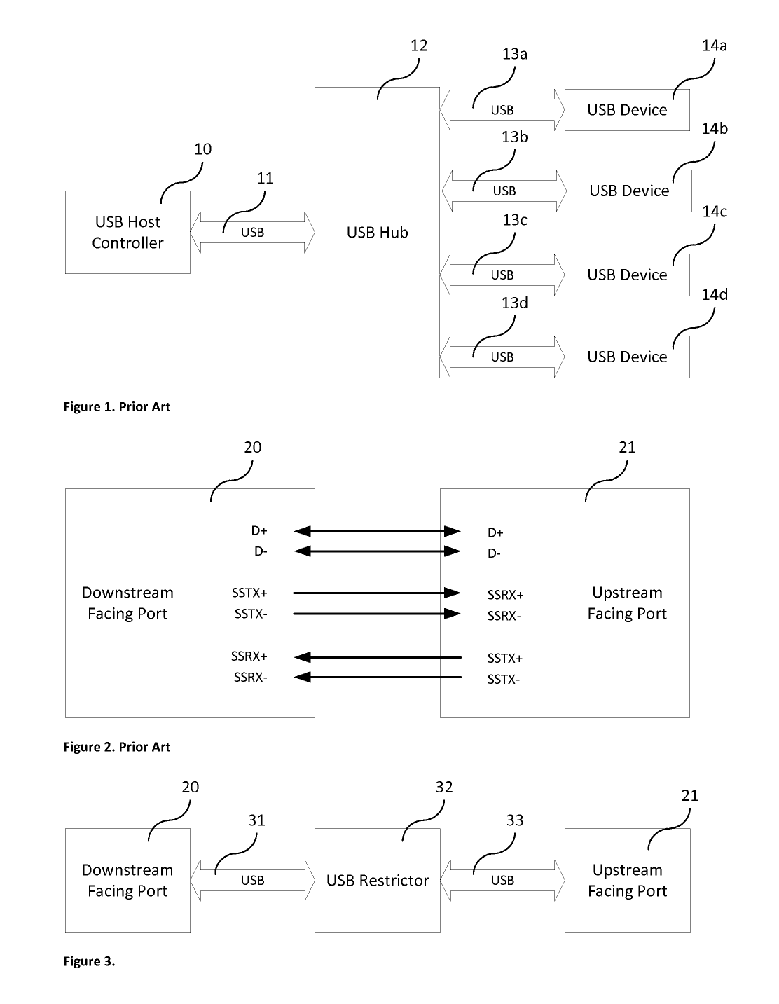

FIG. 1 is a block diagram of a typical USB system according to the prior art USB specifications. In this arrangement, a USB host controller (10) communicates with one or a plurality of USB devices (14a-d) over a USB connection (11), a USB hub (12) and one or a plurality of subsidiary USB connections (13a-d). The USB hub (12) enables a plurality of USB devices to share a common upstream connection (11) by generating one or a plurality of subsidiary downstream connections (13a-d) from said common upstream connection (11). According to the USB specifications, a USB hub may be connected to another USB hub up to a maximum depth of five tiers (five hubs in series). A typical USB hub is equipped with four downstream ports, but hubs may possess as few as two downstream ports or as many as 16 downstream ports.

A USB host controller is commonly implemented as an Application Specific Integrated Circuit (ASIC) and is included in most personal computers, servers, laptops and many other intelligent devices.

FIG. 2 is a block diagram of a USB connection according to the prior art USB specifications. A USB connection is established between the downstream-facing port (20) of an upstream USB unit and the upstream facing port (21) of a downstream USB unit. Said upstream USB unit may be a USB host controller (10) or a USB hub (12). Said downstream USB unit may be a USB hub (12) or a USB device (14). The components of a USB connection have been modified as later versions of the USB specifications have been issued. In addition to a pair of power wires (not shown), the USB 1.0, USB 1.1 and USB 2.0 specifications all operate over a single pair of wires, labelled D+ and D− in FIG. 2. The USB 3.0 specification also introduced two additional pairs of wires, labelled SSTX+/SSTX− and SSRX+/SSRX− in FIG. 2.

FIG. 3 is a block diagram of a USB connection according to the present invention. In this arrangement, the connection of FIG. 2 is modified to include a USB restrictor unit (32) between downstream facing port (20) and upstream facing port (21). The single USB connection of FIG. 2 between downstream facing port (20) and upstream facing port (21) is divided into two separate connections—a first USB connection (31) between downstream facing port (20) and USB restrictor (32), and a second USB connection (33) between USB restrictor (32) and upstream facing port (21).

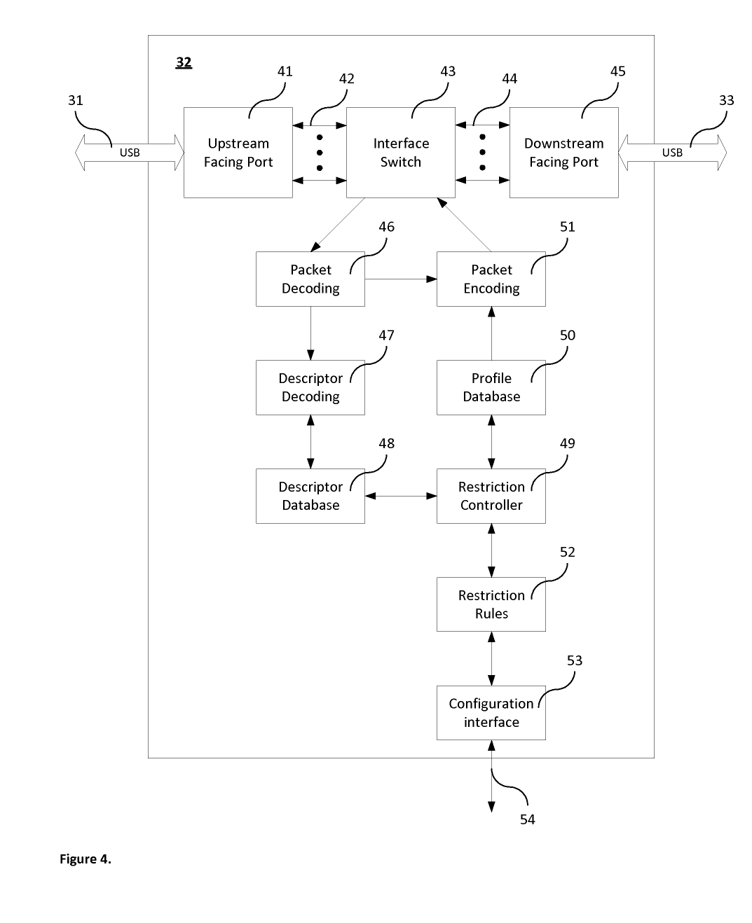

FIG. 4 is a block diagram of a USB restrictor unit (32) according to the present invention. In this arrangement, first USB connection (31) is terminated at upstream facing port (41) and second USB connection (33) is terminated at downstream facing port (45). Said upstream and downstream facing ports (41, 45) serve to convert signals between the transmission format required on USB connections (31, 33) and a digital logic format desired on digital signal sets (42, 44). Interface switch (43) is equipped to monitor said digital signal sets (42, 44) and may allow signals to pass freely from said signal set (42) to signal set (44) and from digital signal set (44) to digital signal set (42). Interface switch (43) is further equipped to detect the start of packet condition on digital signal set (42) or digital signal set (44) and to transmit the corresponding packet data to packet decoding unit (46). Interface switch (43) is yet further equipped to accept packet data from packet encoding unit (51) and to transmit said accepted packet data on digital signal set (42) or digital signal set (44). Since USB restrictor unit (32) is equipped with both an upstream facing port (41) and a downstream facing port (45), USB restrictor unit (32) may be inserted in-line at any position within a USB system. Once inserted, any USB devices located downstream of USB restrictor unit (32) may be provided with restricted operating conditions.

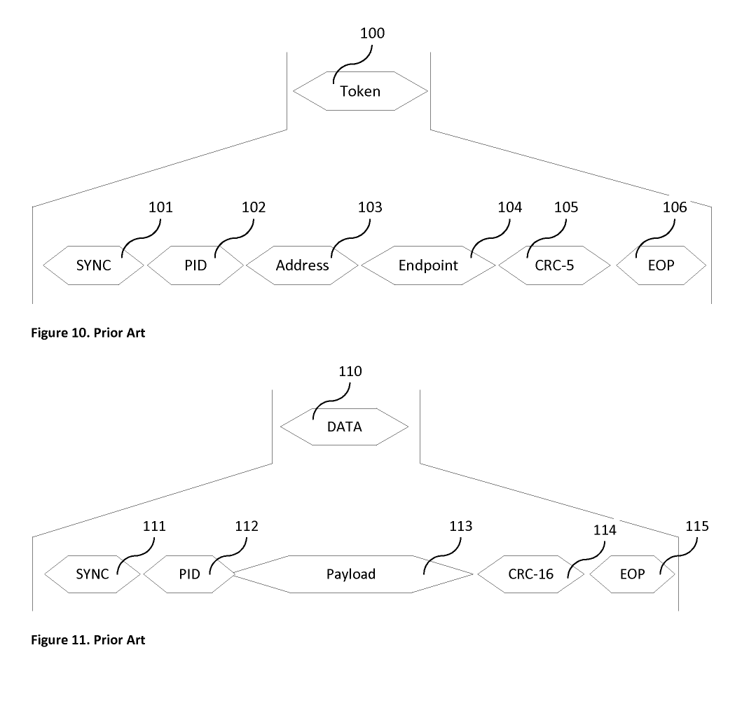

Packet decoding unit (46) is equipped to accept packet data from interface switch (43) and to decode the individual USB fields as identified in FIGS. 10, 11 and 12. Packet decoding unit (46) provides the accepted packet data and the decoded USB field information to packet encoding unit (51). Packet encoding unit (51) may be equipped to generate alternative packet data according to one or a plurality of algorithms, including the methods described in FIGS. 13, 14 and 15. Said alternative packet data is provided to interface switch (43) for transmission on digital signal set (42) or digital signal set (44).

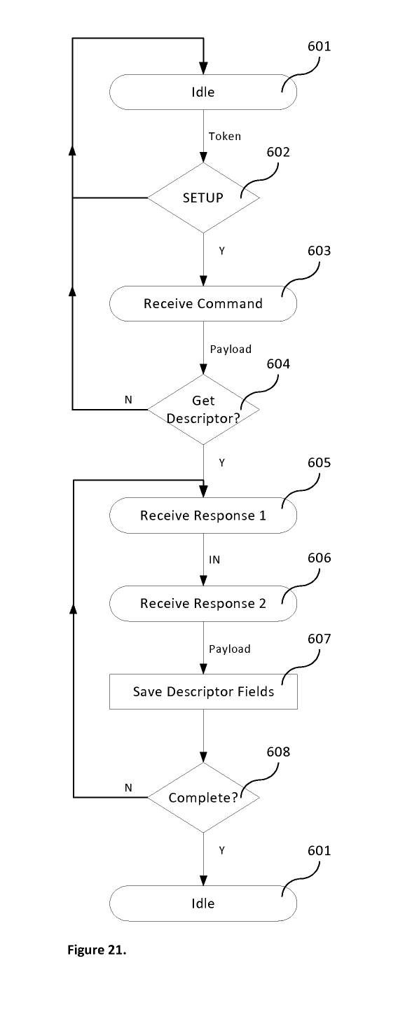

Descriptor decoding unit (47) is equipped to receive USB field information from packet decoding unit (47) and to perform further decoding, according to the algorithm described in FIG. 21, to identify USB descriptor fields as identified in FIGS. 17, 18, 19 and 20. The decoded descriptor information is stored in descriptor database (48) along with the USB address to which it applies. The decoded descriptor information may be used by restriction controller (49) to establish a set of encoding profiles in profile database (50) according to a desired set of restriction rules (52). The desired set of restriction rules may be altered dynamically by instructions received from external connection (54) over configuration interface (53). The encoding profiles in profile database (50) may be used by packet encoding unit (51) to select an algorithm for generating alternative packet data.

The operation of USB restrictor unit (32) will now be further explained by way of example. In this example, a command is received by configuration interface (53) from external connection (54) requiring that all mass storage operations be inhibited. Configuration interface (53) updates restriction rules (52) to include the restriction of USB mass storage interfaces. Following this procedure, a system administrator located at a remote site may issue a series of commands through external connection (54) and configuration interface (53), resulting in the creation of a set of updated restriction rules (52). Said updated restriction rules may be stored in non-volatile memory to enable the configuration of USB restrictor unit (32) to be preserved over a long period of time and, in particular, to survive periods of power interruption. Restriction controller (49) may use the information stored in restriction rules (52) to control the handling of USB transactions on a case-by-case basis. For ease of understanding, it will be assumed that the USB system is currently idle and that no USB devices are attached through USB interface (33).

When a new USB device is attached to the system at USB interface (33), the device is enumerated by a USB host controller attached through USB interface (31). Enumeration occurs when the host controller issues a SETUP token followed by a DATA packet identifying that descriptor information is required from the USB device. The presence of SETUP and DATA packets is detected by packet decoding unit (46) and the decoded field information is passed to descriptor decoding unit (47) for further analysis. Descriptor decoding unit (47) identifies from the data packet that a descriptor is being requested from the USB device.

According to the USB specifications, the host controller must then issue an IN command to the USB device and the device must respond with a DATA packet or packets containing the requested descriptor or descriptors. The corresponding packets are also decoded by packet decoding unit (46) and the data field belonging to the DATA packet is passed to descriptor decoding unit (47) which parses the information to extract the USB descriptors and stores the desired parameters of those descriptors in descriptor database (48) along with the USB address of the device to which they apply.

Restriction controller (49) compares the descriptor parameters stored in descriptor database (48) with the restriction rules (52) and determines that a particular interface of the USB device at the known USB address is of mass storage class and should be restricted. Accordingly, restriction controller (49) updates profile data base (50) with the identity of the USB address and endpoints to be restricted. When subsequent IN or OUT commands are sent from the host controller to the mass storage device, the presence of said IN or OUT commands is detected by packet decoding unit (46) and packet encoding unit (51) is alerted. Packet encoding unit (51) identifies that the target address and endpoints are restricted using information received from the packet decoding unit (51) and the restriction profiles stored in profile database (50). Packet encoding unit (51) then applies a selected restriction algorithm to the received packets and transmits an altered version of the received packets to interface switch (43) for delivery to the USB host controller or USB device.

It will be apparent to those skilled in the art that communication between the functional blocks of which USB restrictor unit (32) is comprised may be performed on a bit, byte (8-bit) or word (16-bit) basis and that combinations of said values may be employed. It will be further apparent to those skilled in the art that a homogenous application of bit, byte and word communications need not be utilised throughout USB restrictor unit (32).

In a particular embodiment of the current invention, functional units (41) to (53) may be implemented as discrete ASICs mounted on a common printed circuit board. In a further embodiment of the current invention, functional units (41) to (53) may be implemented as logic elements within a single ASIC or FPGA (Field Programmable Gate Array). It will be apparent to those skilled in the art that other combinations of ASICs and FPGAs are also possible.

In a particular embodiment of the current invention, external connection (54) may consist of a set of pins on a logic element that is used to implement configuration interface (53). In a further embodiment of the current invention, external connection (54) may be a processor bus enabling configuration interface (53) to be controlled by an external computer. In a yet further embodiment of the current invention, external connection (54) may be a data communications interface, such as an Ethernet interface, enabling configuration interface (53) to be controlled by a remote computer located on a data communications network. In a yet further embodiment of the current invention, external connection (54) may be a wireless communications interface, such as a WiFi interface, enabling configuration interface (53) to be controlled by a remote computer located on a wireless communications network.

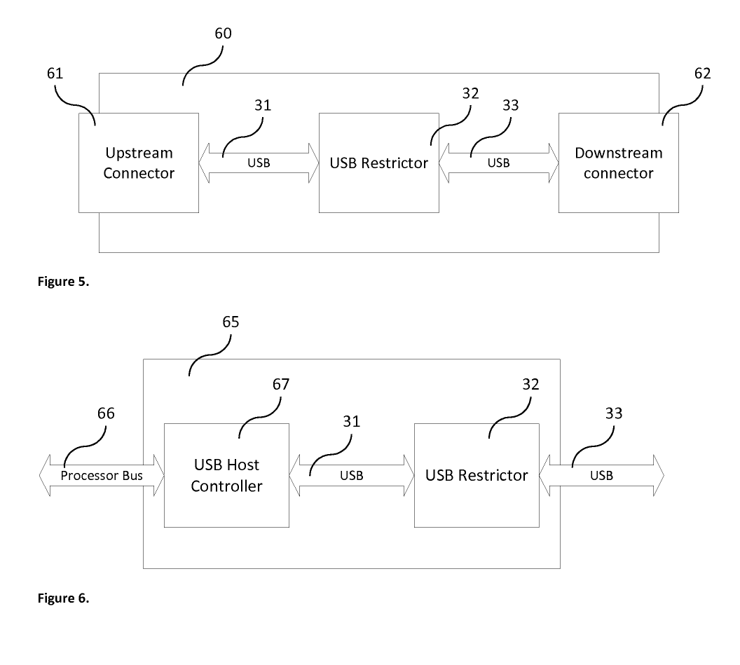

FIG. 5 is a block diagram showing a USB restrictor system (60) constructed as a stand-alone unit according to the current invention. In this arrangement, an upstream connector (61) is provided for connection to an external USB interface. Said upstream connector (61) is connected to USB restrictor (32) by upstream USB connection (31). Similarly, a downstream connector (62) is provided for connection to an external USB interface. Said downstream connector (62) is connected to USB restrictor (32) by downstream USB connection (33).

In a particular embodiment of the current invention, upstream connector (61), USB restrictor (32) and downstream connector (62) are components mounted on a single printed circuit board (PCB) and the USB connections (31), (33) are implemented as electrical traces on said PCB. The PCB may then be installed in a case to create a stand-alone unit that can be employed in a wide variety of USB systems.

In a further embodiment of the present invention, upstream connector (61) may be implemented as a USB plug and USB connection (31) may be implemented as a captive cable to create a USB dongle form factor.

In a yet further embodiment of the present invention, upstream connector (61) and downstream connector (62) may be implemented as USB plugs, and USB connections (31) and (33) may be implemented as captive cables to create an active USB cable form factor.

FIG. 6 is a block diagram showing a USB restrictor system constructed by integrating a USB restrictor unit with a USB host controller according to the current invention. In this arrangement, a processor bus (66) is provided for connection to a local host computer and a USB connection (33) is provided for the attachment of USB hubs and devices. A USB host controller (67) is interfaced to a USB restrictor unit (32) through USB connection (31).

It will be apparent to those skilled in the art that the restrictor system (65) may be implemented in a variety of technologies. USB host controller (67) and USB restrictor unit (32) may be implemented as discrete ASICs and mounted on a small PCB or multi-chip module. Alternatively, USB host controller (67) and USB restrictor unit (32) may be implemented as discrete logic blocks contained within a single FPGA or ASIC. It will also be apparent to those skilled in the art that USB host controller (67) and USB restrictor unit (32) may be more tightly integrated and that USB connection (31) may be replaced by an internal bus in such an implementation.

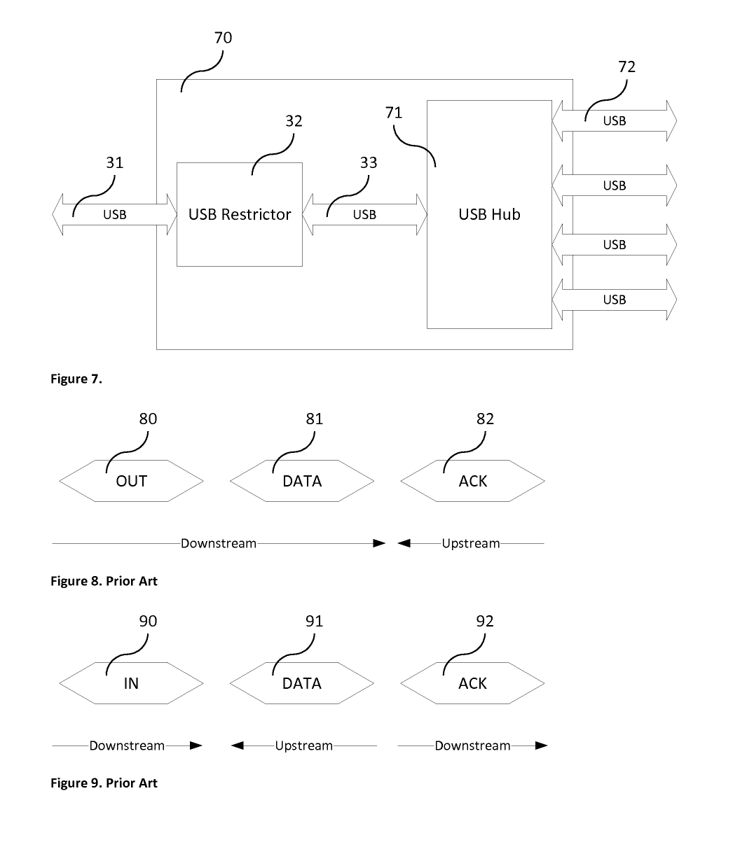

FIG. 7 is a block diagram showing a USB restrictor system constructed by integrating a USB restrictor unit with a USB hub according to the current invention. In this arrangement, an upstream USB connection (31) is provided for attaching USB restrictor system (70) to a USB host controller or USB hub, and a plurality of downstream USB connections (72) are provided for attaching USB hubs and USB devices. A USB hub (71) is interfaced to a USB restrictor unit (32) through USB connection (33).

It will be apparent to those skilled in the art that the restrictor system (70) may be implemented in a variety of technologies. USB hub (71) and USB restrictor unit (32) may be implemented as discrete ASICs and mounted on a small PCB or multi-chip module. Alternatively, USB hub (71) and USB restrictor unit (32) may be implemented as discrete logic blocks contained within a single FPGA or ASIC. It will also be apparent to those skilled in the art that USB hub (71) and USB restrictor unit (32) may be more tightly integrated and that USB connection (33) may be replaced by an internal bus in such an implementation. It will be further apparent to those skilled in the art that the number of downstream USB connections (72) may be varied within the limits of the USB specifications.

FIG. 8 is a waveform diagram showing the structure of a USB OUT transaction according to the prior art USB specifications. An OUT transaction is composed of two separate packets issued in short succession by a USB host controller, followed by an optional handshake packet issued by a USB device. The first packet (80) is referred to as an OUT token and the second packet (81) is referred to as a DATA packet. The third packet (82) is referred to as a handshake packet. As shown by the arrows in FIG. 8, the packets (80, 81) issued by the USB host controller travel in the downstream (host to device) direction whereas packet (82) travels in the upstream (device to host) direction. The internal structure of packets (80), (81) and (82) will be further described in the following figures. The requirement for a handshake packet (82) to be issued by a USB device is dependent upon the type of endpoint to which the token packet is addressed. If the addressed endpoint is of isochronous type then a handshake is not expected.

FIG. 9 is a waveform diagram showing the structure of a USB IN transaction according to the prior art USB specifications. An IN transaction is composed of an IN token (90) issued by a USB host controller, a DATA packet (91) issued by a USB device, and an optional handshake packet (92) issued by said USB host controller. As shown by the arrows in FIG. 9, the direction of packet transfer reverses after each packet is issued. The requirement for a handshake packet (92) to be issued by a USB host controller is dependent upon the type of endpoint to which the token packet is addressed. If the addressed endpoint is of isochronous type then a handshake is not expected.

FIG. 10 is a waveform diagram showing the structure of a USB token packet according to the prior art USB specifications. A USB token packet (100) is composed of a series of consecutive fields with no intervening transmission gaps. The first field is the SYNC field (101) which is designed to contain sufficient electrical transitions to enable a receiving unit to lock on to the transmission. The second field is the packet identifier (PID) field (102) which identifies the required action to be taken. Typical token PID's include IN, OUT and SETUP actions. The third field is the address field (103) which contains the address of the USB device or hub to which the token is directed. A USB address may have any value between 0 and 127. The fourth field is the endpoint field (104) which identifies a particular function supported by a USB device or hub. A USB endpoint may have any value between 0 and 15. The fifth field is a cyclic redundancy check (CRC-5) field (105) which enables the receiving unit to check that the token has been received without error. The sixth field is an end of packet (EOP) field (106) which enables the receiving unit to recognise that the packet is complete and to return to the idle state.

The structure of USB OUT token (80) of FIG. 8 and the USB IN token (90) of FIG. 9 both follow the structure defined by USB token packet (100).

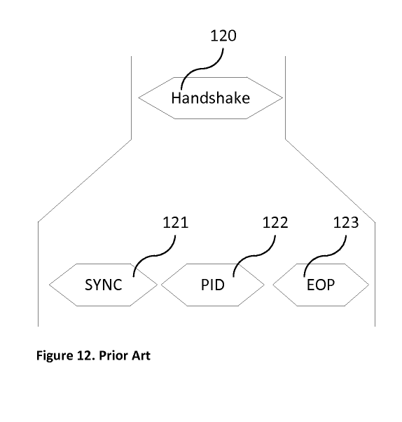

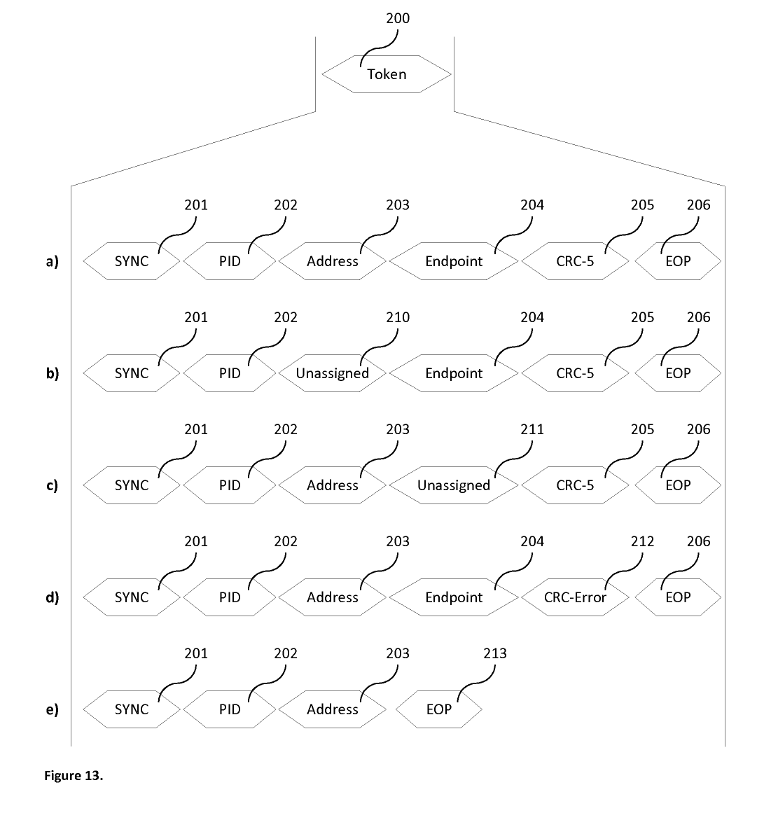

FIG. 11 is a waveform diagram showing the structure of a USB DATA packet according to the prior art USB specifications. A USB DATA packet (110) is composed of a series of consecutive fields with no intervening transmission gaps. The first field is the SYNC field (111) which is designed to contain sufficient electrical transitions to enable a receiving unit to lock on to the transmission. The second field is the packet identifier (PID) field (112) which identifies the required action to be taken. Typical data PID's include DATA0, DATA1, DATA2 and MDATA actions. The third field is the data payload field (113) which contains the application data relevant to the instruction. According to the USB 2.0 specification, the length of the payload field may vary from 0 to 1024 bytes. The fourth field is a cyclic redundancy check (CRC-16) field (114) which enables the receiving unit to check that the entire token has been received without error. The fifth field is an end of packet (EOP) field (115) which enables the receiving unit to recognise that the packet is complete and to return to the idle state.

The structure of USB DATA packet (81) of FIG. 8 and USB DATA packet (91) of FIG. 9 both follow the structure defined by USB DATA packet (110).

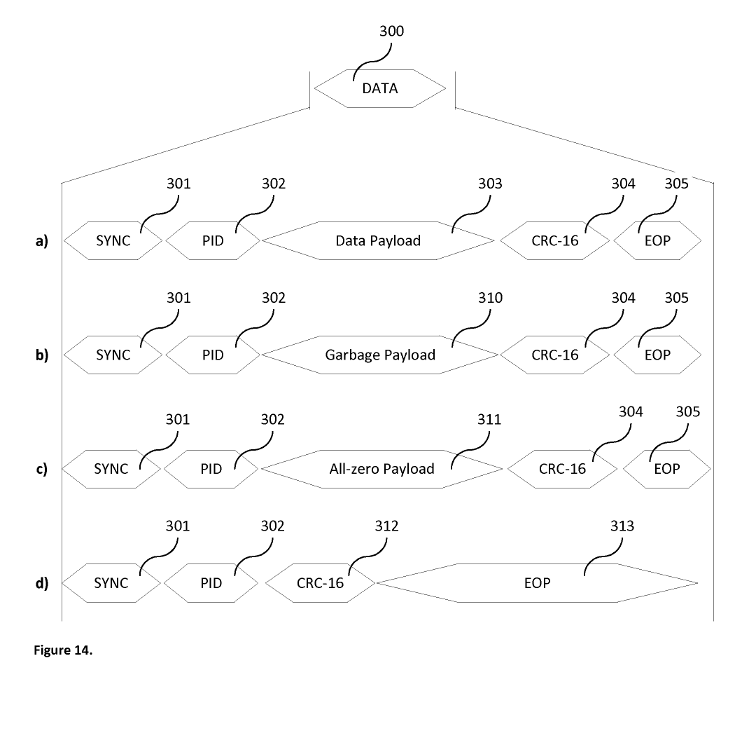

FIG. 12 is a waveform diagram showing the structure of a USB handshake packet according to the prior art USB specifications; A USB handshake packet (120) is composed of a series of consecutive fields with no intervening transmission gaps. The first field is the SYNC field (121) which is designed to contain sufficient electrical transitions to enable a receiving unit to lock on to the transmission. The second field is the packet identifier (PID) field (122) which identifies the result of the associated transaction. Typical handshake PID's include ACK, NAK and STALL results. The third field is an end of packet (EOP) field (123) which enables the receiving unit to recognise that the packet is complete and to return to the idle state.

The structure of USB handshake packet (82) of FIG. 8 and USB handshake packet (92) of FIG. 9 both follow the structure defined by USB handshake packet (120).

FIG. 13 is a waveform diagram showing samples of the possible structures of a USB token packet (200) according to the current invention. Any or all of these techniques, or other similar techniques, might be used. In a first method (a), the token packet is unchanged and contains SYNC field (201), PID field (202), address field (203), endpoint field (204), CRC-5 field (205) and EOP field (206). In a second method (b), address field (210) is altered to a value that is not assigned to any USB device. In a third method (c), endpoint field (211) is altered to a value that is not assigned to any function within the addressed USB device. In a fourth method (d), CRC-5 field (212) is altered to a value that will cause a CRC error to be detected by the addressed USB device. In a fifth method (e), EOP field (213) is issued prematurely in place of endpoint field (204) and CRC-5 field (205). It will be apparent to those skilled in the art that variations on these methods are possible and that the methods may be combined in a variety of ways.

Referring to FIG. 3, token packet (200) may be issued on second USB connection (33) by USB restrictor unit (32) in response to an OUT token (80) or an IN token (90) being received on first USB connection (31).

FIG. 14 is a waveform diagram showing samples of the possible structures of a USB DATA packet (300) according to the current invention. Again, any or all of these techniques, or other similar techniques, might be used. In a first method (a), the data packet is unchanged and contains SYNC field (301), PID field (302), data payload field (303), CRC-16 field (304) and EOP field (305). In a second method (b), data payload field (303) is replaced by garbage payload field (310). In a third method (c), data payload field (303) is replaced by an all-zero payload field (311). In a fourth method (d), data payload field (303) is eliminated and the packet is completed with a recalculated CRC-16 field (312) and EOP field (313). Said eliminated payload field may also be described as a null-data field. Said EOP field (124) may be stretched such that the overall length of the DATA packet is equivalent to that of original packet (81). It will be apparent to those skilled in the art that variations on these methods are possible and that the methods may be combined in a variety of ways.

Referring to FIG. 3, data packet (300) may be issued on second USB connection (33) by USB restrictor unit (32) in response to a data packet (81) being received on first USB connection (31). Also referring to FIG. 5, data packet (300) may be issued on first USB connection (31) by USB restrictor unit (32) in response to a data packet (91) being received on second USB connection (31).

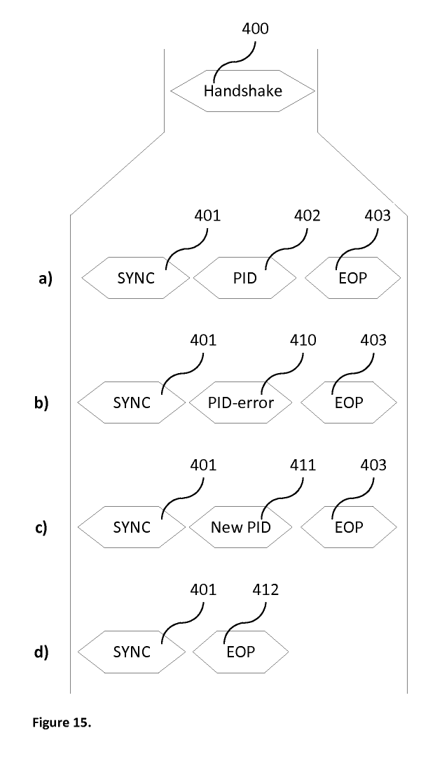

FIG. 15 is a waveform diagram showing samples of the possible structures of a USB handshake packet (400) according to the current invention. Again, any or all of these techniques, or other similar techniques, might be used. In a first method (a), the handshake packet is unchanged and contains SYNC field (401), PID field (402) and EOP field (403). In a second method (b), PID field (402) is replaced by a PID-error field (410). In a third method (c), PID field (402) is replaced by a new PID field (411). In a fourth method (d), PID field (402) is eliminated and the packet is completed with a premature EOP field (412). In a fifth method (not shown) handshake packet (400) may be suppressed in its entirety. It will be apparent to those skilled in the art that variations on these methods are possible and that the methods may be combined in a variety of ways.

Referring to FIG. 3, handshake packet (400) may be issued on second USB connection (33) by USB restrictor unit (32) in response to a handshake packet (92) being received on first USB connection (31). Also referring to FIG. 5, handshake packet (400) may be issued on first USB connection (31) by USB restrictor unit (32) in response to a handshake packet (82) being received on second USB connection (31).

In a preferred embodiment of the present invention, said PID-error field (410) is achieved by failing to provide a “one's-complement” of the packet type element in the four-bit check element that comprise a USB PID field. In a further preferred embodiment of the present invention, said new PID field (411) is achieved by setting the packet type element to the value corresponding to a NAK response. In a yet further preferred embodiment of the present invention, said new PID field (411) is achieved by setting the packet type element to the Reserved value.

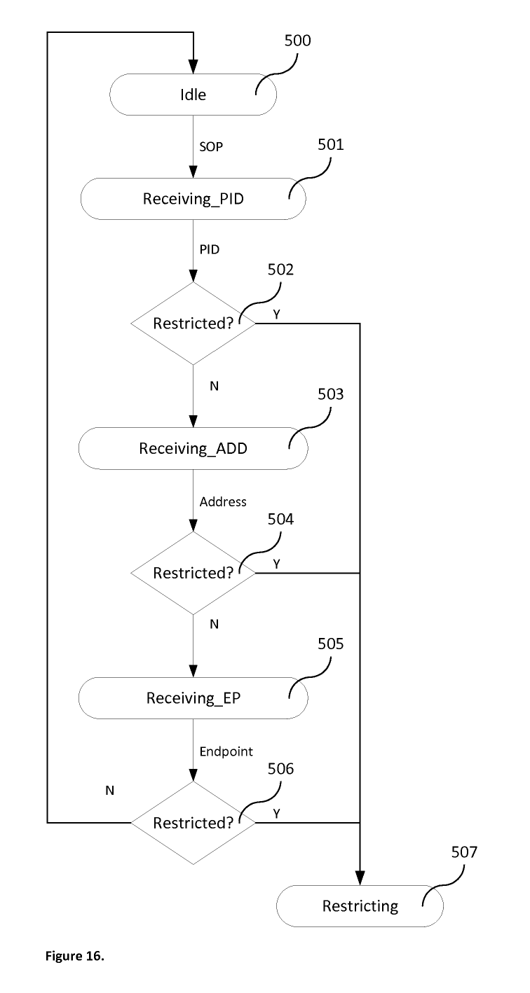

FIG. 16 is a flowchart showing a method for identifying a USB packet that may be altered, according to the current invention. The system is initialised to the Idle state (500) in which the USB connection is monitored for packet activity. If a start of packet (SOP) field is detected then the system transitions to the receiving_PID state (501) and continues to monitor the USB connection for following fields. When a packet identifier (PID) field is recognised, the received PID is compared with a stored list of restriction criteria. If the restriction criteria indicate that the transaction should be restricted based on the received PID alone, then the system transitions to restricting state (507). Otherwise, the system transitions to the receiving_ADD state (503) and continues to monitor the USB connection for following fields. When an address field is recognised, the received address and PID fields are compared with a stored list of restriction criteria. If the restriction criteria indicate that the transaction should be restricted based on the received address and PID fields, then the system transitions to restricting state (507). Otherwise, the system transitions to the receiving_EP state (505) and continues to monitor the USB connection for following fields. When an endpoint field is recognised, the received endpoint, address and PID fields are compared with a stored list of restriction criteria. If the restriction criteria indicate that the transaction should be restricted based on the received endpoint, address and PID fields, then the system transitions to restricting state (507). Otherwise, the system returns to the idle state (500) and waits for the next SOP event.

If an endpoint field is detected by receiving state (201) then the value of said endpoint field is compared to zero. If the endpoint field is zero then the system returns to idle state (200). If the endpoint field is not zero, then the system enters the restricting state (202) where the following data packet will be detected and altered.

FIG. 17 is a table showing the structure of a device descriptor according to the prior art USB specifications. A USB descriptor is a data structure describing the attributes of a USB device or USB hub. Each descriptor is stored at a USB device or USB hub and may be transmitted to a USB host controller on request. A device descriptor describes general information about a USB device. It includes information that applies globally to the device and all of the device's configurations. A USB device has only one device descriptor.

The device descriptor contains several fields that may be used as criteria for device restriction including the device class (bDeviceClass) at offset 4, the device protocol (bDeviceProtocol) at offset 6, the vendor identifier (idVendor) at offset 8 and the product identifier (idProduct) at offset 10. It will be apparent to those skilled in the art that other fields may also provide criteria for device restriction and that combinations of multiple fields may also be employed.

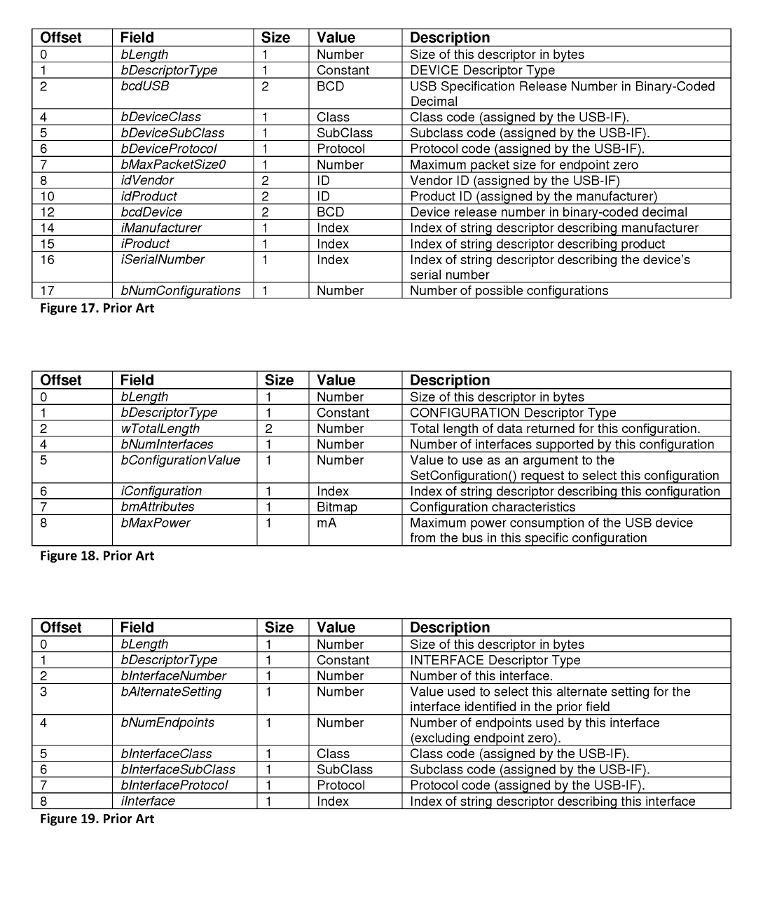

FIG. 18 is a table showing the structure of a configuration descriptor according to the prior art USB specifications. Each USB device or USB hub must support at least one configuration descriptor. A USB device has one or more configuration descriptors. Each configuration has one or more interfaces and each interface has zero or more endpoints.

The configuration descriptor contains little information that may be used directly as criteria for device restriction however it does identify the number of interfaces supported by the configuration.

FIG. 19 is a table showing the structure of an interface descriptor according to the prior art USB specifications. The interface descriptor describes the attributes of a particular function supported by the USB device of USB hub. A single USB device may support multiple functions simultaneously such as a video interface, an audio interface and a mass storage interface.

The interface descriptor contains several fields that may be used as criteria for device restriction including the interface class (bInterfaceClass) at offset 5, the interface sub-class (bInterfaceSubClass) at offset 6 and the interface protocol (bInterfaceProtocol) at offset 7. It will be apparent to those skilled in the art that other fields may also provide criteria for device restriction and that combinations of multiple fields may also be employed.

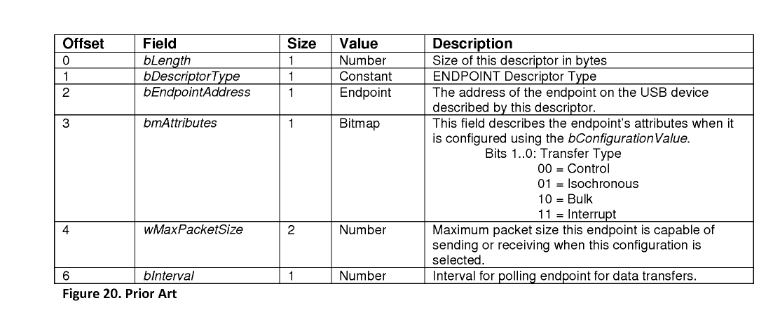

FIG. 20 is a table showing the structure of an endpoint descriptor according to the prior art USB specifications. The endpoint descriptor describes the attributes of a particular endpoint that is able to support communication with a USB host controller. A single USB interface may support multiple endpoints

The endpoint descriptor contains several fields that may be used as criteria for device restriction including the endpoint address (bEndpointAddress) at offset 2, the endpoint attributes (bmAttributes) at offset 3 and the maximum packet size (wMaxPacketSize) at offset 4. It will be apparent to those skilled in the art that other fields may also provide criteria for device restriction and that combinations of multiple fields may also be employed.

FIG. 21 is a flowchart showing a method for capturing descriptor information from a stream of USB traffic. The system is initialised to the Idle state (601) in which the USB connection is monitored for packet activity. When a USB token packet is detected, the system leaves the idle state and the token is compared with that of a SETUP token in conditional statement (602). If the token is a SETUP token then the system waits for the data payload segment of the command at receive command state (603). Otherwise, the system returns to the idle state (601). When a data payload is received, the system leaves state (603) and the data payload is compared with that of a Get_Descriptor command at conditional statement (604). If the data payload corresponds to that of a Get_Descriptor command then the system waits for an IN command to be issued at receive response #1 state (605). When the IN command is detected the system moves to receive response #2 state (606) to await reception of a DATA packet. When the DATA packet is received, the data payload is stored at statement (607) and the response is tested for completeness at conditional statement (608). If the descriptor information is complete then the system returns to the idle state (601). Otherwise the system returns to receive response #1 state (605) to await additional information.

The USB descriptor information captured through this process is used by descriptor decoding unit (47) of FIG. 4 to build descriptor database (48) which may contain the identity (USB Address) and description of each USB device connected downstream of USB restrictor unit (32). Restriction controller (49) may then compare the information in descriptor database (48) with that in restriction rules (52) to determine whether a particular USB device may be permitted to operate. For example, if a USB device at USB address #7, say, is determined through its descriptor to be a mass storage device and the restriction rules have been set to disable all mass storage devices, then restriction controller (49) may set the parameters of profile database (50) to disable the operation of the USB device at USB address #7.

1. A method for restricting the operation of one or a plurality of USB devices wherein said restricted operation is achieved by altering one or a plurality of data fields contained within a USB transaction, wherein said USB transaction is composed of a USB token packet, a USB data packet and an optional USB handshake packet, said method comprising:
a. receiving at a USB restrictor unit a USB token packet;
b. analyzing the constituent fields of said received USB token packet;
c. comparing said analyzed constituent fields with a set of predefined restriction criteria; and
d. altering one or a plurality of data fields within said USB transaction according to the results of said comparison.

2. A method as claimed in claim I wherein said altered one or a plurality of data fields are contained within said USB token packet.

3. A method as claimed in claim 2 wherein said altered data field is selected from the group consisting of an address field, an endpoint field, a CRC field, and an EOP field.

4. A method as claimed in claim 3 wherein said altered data field is an address field, and the alteration of said address field is achieved by setting said address field to a value that is not assigned to a valid USB device.

5. A method as claimed in claim 3 wherein said altered data field is an endpoint field, and the alteration of said endpoint field is achieved by setting said endpoint field to a value that is not assigned to a valid endpoint.

6. A method as claimed in claim 3 wherein said altered data field is a CRC field, and the alteration of said CRC field is achieved by setting said CRC field to a value that will cause a CRC error to be detected.

7. A method as claimed in claim 3 wherein said altered data field is an EOP field, and the alteration of said EOP field is achieved by inserting said EOP field in place of a preceding field.

8. A method as claimed in claim I wherein said altered one or a plurality of data fields are contained within said USB data packet.

9. A method as claimed in claim 8 wherein said altered data field is selected from the group consisting of a data payload field, a CRC field, and an EOP field.

10. A method as claimed in claim 9 wherein said altered data field is a data payload field and the alteration of said data payload field is achieved by changing the value of one or a plurality of data symbols within said data payload field.

11. A method as claimed in claim 10 wherein the alteration of said data payload field is achieved by setting the value of each data symbol within said data payload field to a zero value.

12. A method as claimed in claim 10 wherein the alteration of said data payload field is achieved by eliminating every data symbol within said data payload field.

13. A method as claimed in claim 9 wherein said altered field is a CRC field, and the alteration of said CRC field is achieved by setting said CRC field to a value that will cause a CRC error to be detected.

14. A method as claimed in claim 9 wherein said altered field is an EOP field, and the alteration of said EOP field is achieved by inserting said EOP field in place of a preceding field.

15. A method as claimed in claim I wherein said altered one or a plurality of data fields are contained within said USB handshake packet.

16. A method as claimed in claim I5 wherein said altered data field is a PID field and wherein said PID field comprises a packet type element and a check element, and wherein the alteration of said PID field is achieved by setting said check element to a value that is not the one's complement of said packet type element.

17. A method as claimed in claim I5 wherein said altered data field is an EOP field, and wherein the alteration of said EOP field is achieved by inserting said EOP field in place of a preceding field.

18. A method as claimed in claim I wherein the alteration of said USB transaction is confined to transactions which are: directed towards a non-zero USB address; directed towards one or a plurality of specific USB addresses; and/or are directed towards one or a plurality of specific USB endpoints.

19. A method as claimed in claim I wherein said USB transaction conforms to the requirements of a USB OUT transaction, or to a USB IN transaction.

20. A method as claimed in claim I wherein said USB transaction conforms to the requirements of the USB I.I, the USB 2.0, or the USB 3.0 specification.

21. An apparatus for restricting the operation of one or a plurality of USB devices wherein said restricted operation is achieved by altering one or a plurality of USB packets, said apparatus comprising:
a. a decoding unit for capturing the fields of a USB token packet;
b. a comparison unit for comparing said captured fields of said USB token packet with a set of predefined restriction criteria; and
c. an encoding unit for generating a replacement USB DATA packet.

22. An apparatus as claimed in claim 21 also comprising a USB host controller for generating USB transactions.

23. An apparatus as claimed in claim 21 also comprising a USB hub for connecting one or a plurality of USB devices.

24. An apparatus as claimed in claim 21 also comprising a USB cable for connecting said restricting apparatus to an upstream USB host controller or USB hub.

25. An apparatus as claimed in claim 21 also comprising a USB cable for connecting said restricting apparatus to a downstream USB hub or USB device.

26. A method for selecting a USB data stream wherein said USB data stream is directed at an individual endpoint belonging to an individual USB device, said method comprising:
a. capturing at a USB restrictor unit a USB descriptor structure;
b. extracting one or a plurality of fields from said USB descriptor structure;
c. comparing said one or a plurality of extracted fields with a set of restriction criteria; and
d. setting restriction parameters that limit the operation of said USB data stream.

27. A method as in claim 26 wherein a plurality of endpoints belongs to an individual USB device.

28. (canceled)
